(19) United States
(12) Patent Application Publication
(10) Pub. No.: US 2011/0125826 A1
(43) Pub. Date: May 26, 2011

(54) STALKING SOCIAL MEDIA USERS TO MAXIMIZE THE LIKELIHOOD OF IMMEDIATE ENGAGEMENT

(75) Inventors: George ERHART, Loveland, CO (US); David SKIBA, Golden, CO (US); Valentine C. MATULA, Granville, OH (US)

(73) Assignee: AVAYA INC., Basking Ridge, NJ (US)

(21) Appl. No.: 12/706,942

(22) Filed: Feb. 17, 2010

Related U.S. Application Data
(63) Continuation-in-part of application No. 12/704,244, filed on Feb. 11, 2010.
(60) Provisional application No. 61/263,013, filed on Nov. 20, 2009.

(51) Int. Cl. G06F 15/16

(52) U.S. Cl. 709/202; 709/206

(57) ABSTRACT

Methods and the systems allow a contact center to determine the presence, in near real time, of a user on a social media network. The contact center can receive an identity for a user and associate the user identity with one or more other identities, such as, a screen name, an email, or some other identity that may be used on social media networks. The contact center may then review posts to several social media networks, by several people, to determine one of the posts includes an identity of the user. If one of the posts does include the identity of the user, then the contact center may quickly introduce a human agent to the user on that social media network. As such, by “stalking” the social media user, the contact center is able to engage the customer in near real time or real time communications over the social media network.

### CLAIM OF PRIORITY

This application claims priority to U.S. Provisional Application Ser. No. 61/263,013, filed Nov. 20, 2009, entitled “GEO POD SYSTEM”, and is a continuation-in-part application of U.S. application Ser. No. 12/704,244, filed Feb. 11, 2010, entitled “SOCIAL MEDIA CONTACT CENTER DIALOG SYSTEM”, which are both incorporated herein by reference in their entirety.

### BACKGROUND

Unlike phone calls, social media communications are not generally real time communications. For example, a social media user may post information to a social media network and then receive a response at a later time. The responses are not necessary sent immediately to the social media user but may be delayed by some period of time, e.g. an hour, a day, etc.

Contact centers interact with customers to address questions or concerns of the customer. A contact center may want to engage a customer or user that is using a social media network. Further, the contact center needs to maintain the efficiency of the human agents that work within the contact center. To maintain efficiency, the human agents cannot wait for responses or communications from a customer. Thus, the agent needs to be able to engage in real time communications i.e., communications with short delays between responses. For reasons explained above, it is difficult and problematic for human agents to communicate in real time with a user of a social media networks. Thus, there exists a problem in allowing human agents in a contact center to engage social media users in a communication that optimizes the effectiveness of the contact and the availability of the resources of the contact center.

### SUMMARY

It is with respect to the above issues and other problems that the embodiments presented herein were contemplated. Embodiments of the methods and the systems presented herein allow a contact center to determine the presence, in near real time, of a user on a social media network. The contact center can receive an identity for a user and associate the user identity with one or more other identities, such as, a screen name, an email, or some other identity that may be used on social media networks. The contact center may then review posts to several social media networks by several people, to determine one of the posts includes an identity of the user. If one of the posts does include the identity of the user, then the contact center may quickly introduce a human agent to the user on that social media network. As such, by “stalking” the social media user, the contact center is able to engage the customer in near real time or real time communications over the social media network.

The embodiments described herein provide a social media gateway that can be used to gather information on social network users. In the cases where the social media network user has a prior relationship with the enterprise, enterprise data may be consulted to find which social media networks this user was a member of and the necessary access information.

The system can monitor the social media networks being used by the target customer and wait for them to “post” a message to a channel. The system can then immediately or in real time post an invitation to communicate via the same social media network, if there is a human agent in the contact center available to take over the “conversation” with that user. By watching for a user post, the system can determine that the user is currently looking at the social media network, and the user is likely to be available to respond to the invitation and, thus, engage with the contact center human agent. As explained above, by stalking the user on the social media networks, the contact center system can optimize the chances that the user being contacted will engage in a two-way dialog.

As an example, a bank can start an outbound campaign for all customers who might be eligible for a mortgage refinance. The list of potential outbound contacts (i.e., the customers) is generated from the bank contact database. The contact center system runs through the list of potential candidates who have available social media contact information. The system then starts the stalking process on each candidate. When the system has determined that a user is “active” in a social media channel or network and an agent is available, the automated response (i.e., the invitation) is sent to the customer to solicit the customer. Since the likelihood of a response is good when the customer is active in the social media channel, the agent will be ready to engage the customer, if the customer responds to the request. Once the connection is made, through the social media channel, or possibly escalating to chat or even phone contact, the normal sales process can continue. The system repeats the process for multiple agents and multiple simultaneous automated stalking processes.

In some embodiments, the outreach to the customer via the social channel has a timeout value associated with the invitation. If the timeout expires without response from the user, the agent can be placed back into the available state for assignment to other work.

If the social channel includes geo-location information with the user social media message post (as Twitter is doing), then that location information may be used to tie the social media user to a possible physical address. If the contact center has a list of physical addresses and phone numbers for the user (from enterprise data), then the outreach can be done via a traditional phone call instead of using the social media network. In this embodiment, the social media communication acts as a presence detector that can stimulate the outbound contact and provides the benefit of knowing that the user is at the location with the phone at the time of the call.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “stalking” means the process of determining a person is presently using a social media network and can be contacted on that social media network in real time.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

### BRIEF DESCRIPTION OF THE DRAWINGS

The present disclosure is described in conjunction with the appended figures:

FIG. 1 is a block diagram of an embodiment of a communication system operable to interact with persons using social media networks;

FIG. 2A is a block diagram of an embodiment of a social media gateway;

FIG. 2B is a block diagram of an embodiment of a dialog system;

FIG. 3 is a block diagram of an embodiment of a dialog data structure;

FIGS. 4A and 4B are flow diagrams of an embodiment of a process for engaging a social media user in a communication after responding to a post in near real time;

FIG. 5 is a flow diagram of an embodiment of a process for generating a dialog data structure related to stalking social media user;

FIG. 6 is a block diagram of an embodiment of a computing environment;

FIG. 7 is a block diagram of an embodiment of a computing system.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

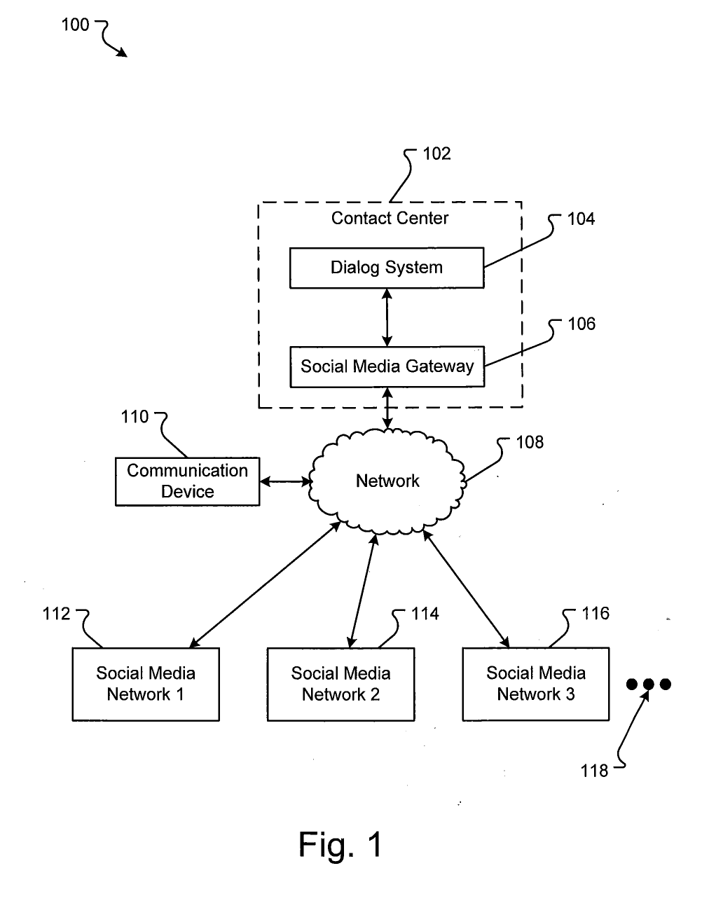

A communication system 100, for interacting with persons using social media is shown in FIG. 1. The communication system 100 can include a contact center 102, a network 108, and one or more types of social media networks or systems, such as social media network 1 112, social media network 2 114, and social media network 3 116. Social media networks 1 112, 2 114, and/or 3 116 can be any social media including, but not limited to, networks, websites, or computer enabled systems. For example, a social media network may be MySpace, Facebook, Twitter, Linked-In, Spoke, or other similar computer enabled systems or websites. The communication system 100 can communicate with more or fewer social media networks 112, 114, and/or 116 than those shown FIG. 1, as represented by ellipses 118.

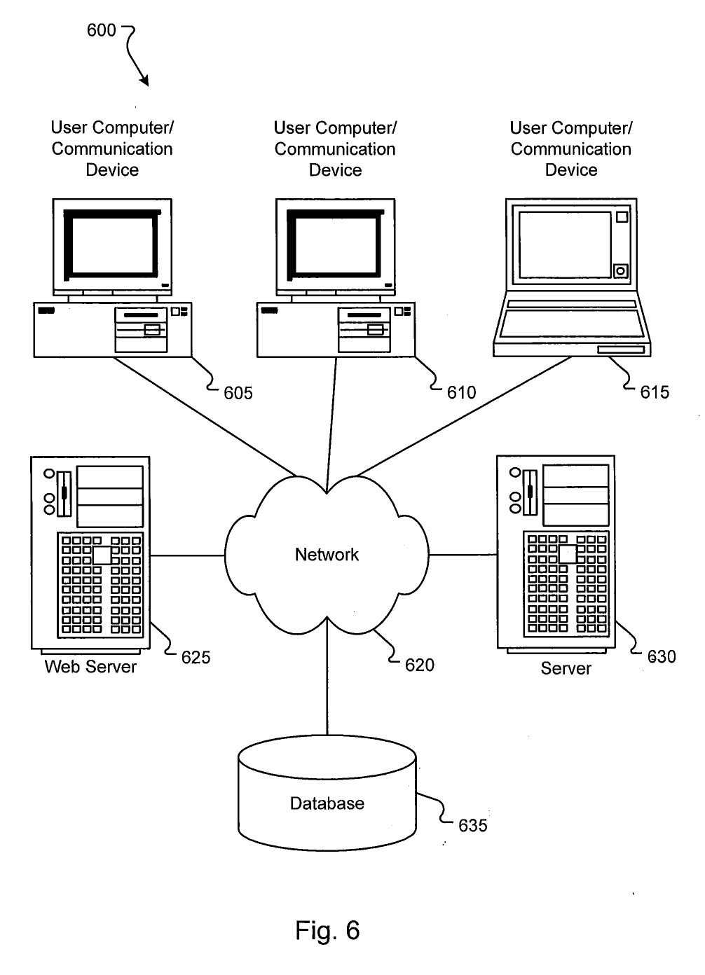

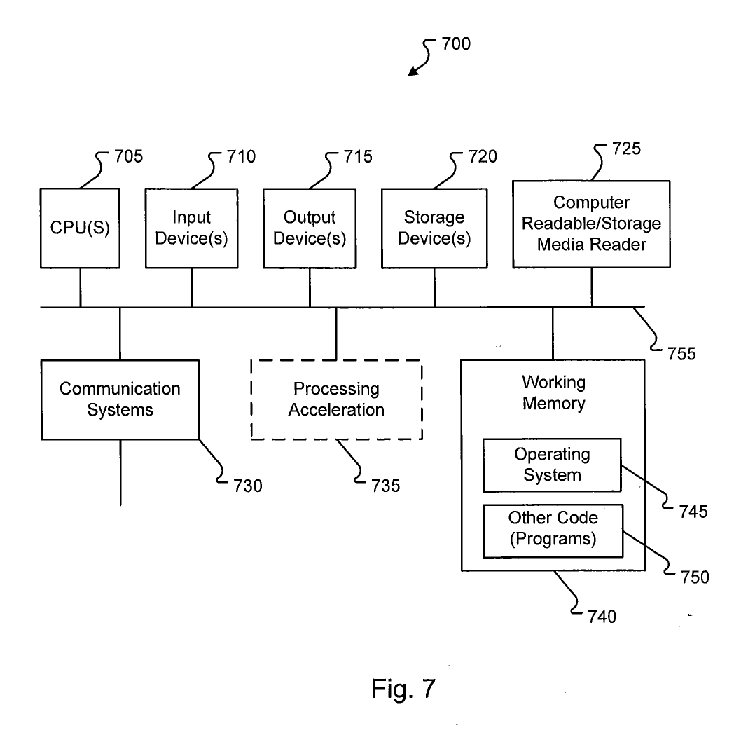

The network 108 can be any network or system operable to allow communication between the contact center 102 and the one or more social media networks 112, 114, and/or 116. The network 108 can represent any communication system, whether wired or wireless, using any protocol and/or format. The network 108 provides communication capability for the contact center 102 to communicate with sites corresponding to the one or more social media networks 112, 114, and/or 116. However, the network 108 can represent two or more networks, where each network is a different communication system using different communication protocols and/or formats and/or different hardware and software. For example, network 108 can be a wide area network, local area network, the Internet, a cellular telephone network, or some other type of communication system. The network may be as described in conjunction with FIGS. 6 and 7.

A contact center 102 can be a system that can communicate with one or more persons that use social media networking sites. The contact center 102 can be hardware, software, or a combination of hardware and software. The contact center 102 can be executed by one or more servers or computer systems, as described in conjunction with FIGS. 6 and 7. The contact center 102 can include all systems, whether hardware or software, that allows the contact center 102 to receive, service, and respond to directed contacts. For example the contact center 102 can include the telephone or email system, the interface to human agents, systems to allow human agents to service and respond to received contacts, and one or more systems operable to analyze and improve the function of agent interaction.

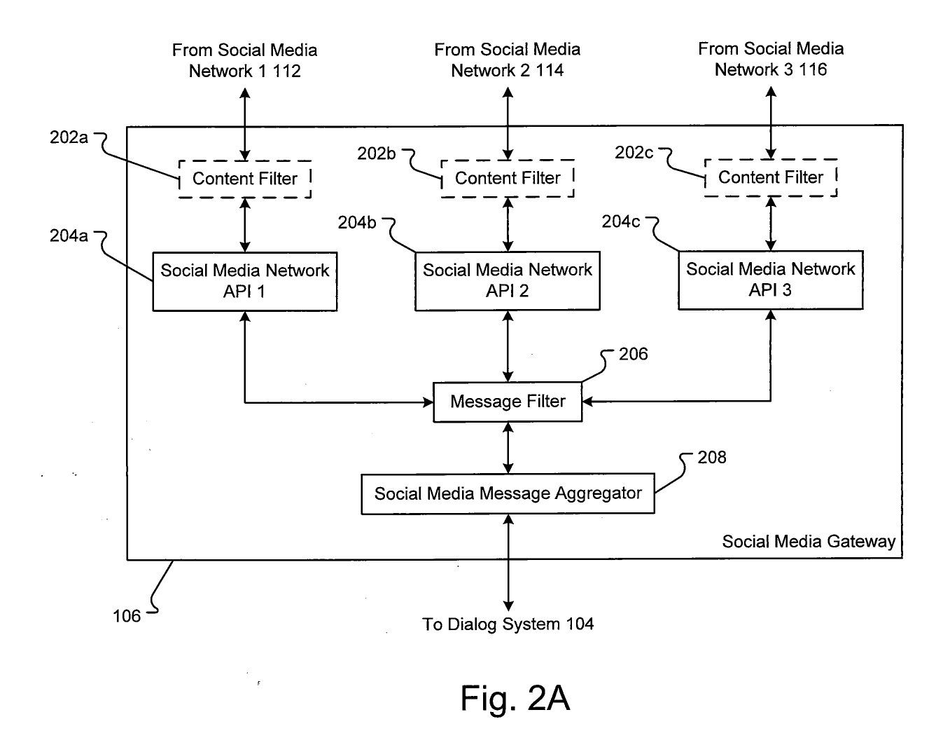

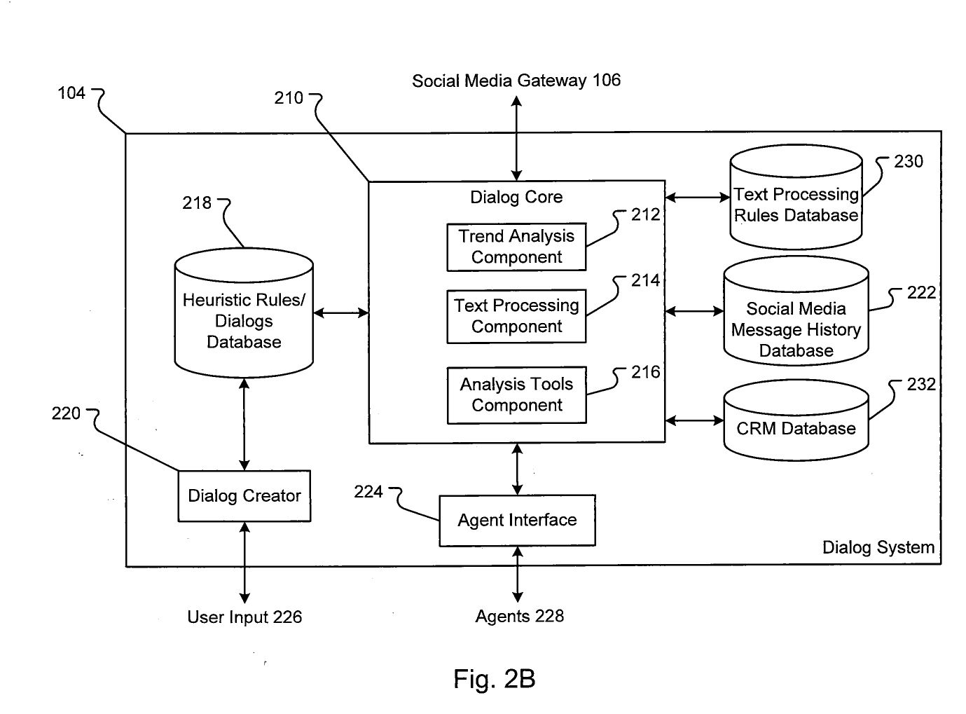

The contact center 102 may include a dialog system 104 and a social media gateway 106. While the dialog system 104 and the social media gateway 106 are shown as being a part of the contact system 102, in other embodiments, the dialog system 104 and/or the social media gateway 106 are separate systems or functions executed separately from the contact center 102 and/or executed by a third party. The dialog system 104 may process and receive messages. The social media gateway 106 can receive and translate messages from the one or more social media networks 112, 114, and/or 116. An embodiment of the dialog system 104 is described in conjunction with FIG. 2B. An embodiment of the social media gateway 106 is described in conjunction with FIG. 2A.

The contact center 102 may also communicate with one or more communication devices 110. The communication devices 110 can represent a customer's or user's cell phone, email system, personal digital assistant, laptop computer, or other device that allows the contact center 102 to interact with the customer. The contact center 102 can modify a non-direct contact, from a social media network 112, 114, and/or 116, into a directed contact by sending a response message directly to a customer's communication device 110.

An embodiment of the social media gateway 106 is shown in FIG. 2A. The social media gateway 106 can include one or more components which may include hardware, software, or combination of hardware and software. The social media gateway 106 can be executed by a computer system such as those in conjunction with FIGS. 6 and 7. However, in other embodiments, the components described in conjunction with FIG. 2A are logic circuits or other specially-designed hardware that are embodied in a field programmable gate array (FPGA).

Herein, the social media gateway 106 can include one or more content filters 202a, 202b, and/or 202c. A content filter 202 can receive all of the messages for the contact center 102 from a social media network 112, 114, and/or 116 and eliminate or delete those messages that do not require a response. For example, a message between two friends on a Facebook page, if not pertaining to a product or a service of the company operating the contact center 102, may not need a response. As such, the content filter 202 can filter out or delete that non-suitable message from the messages that are received by social media network application programming interface (API) 1 204a, social media network API 2 204b, and/or social media network API 3 204c. With the content filter 202, the social media network API 204 only needs to translate those messages that should be received by the dialog system 104. Translation typically requires the conversion of the message into a different format.

The content filter 202 is provided with one or more heuristics for filter rules from a filter database (not shown). These filter rules can be created by the external customer or internal user (e.g. agent or administrator) of the communication system 100. Thus, the user or customer of the communication system 100 can customize the filtering of messages from social media networks 112, 114, and/or 116. Further, different rules may be applied to different social media networks, as some social media networks may have different types of messages or postings than other types of social media networks.

While the content filter 202 is shown as part of the social media gateway 106, it is to be appreciated that the content filter 202 may be a part of the social media network API 204. The content filter 202 may correspond to the query terms used by the social media network API 204. The content filter 202 or query terms are an argument to the social media network API 204 call. The social media network API 204 can be an application that the social media network 112, 114, and/or 116 provides to access the site. Thus, the social media network API 204 is called and connects the social media gateway 106 to the social media network 112, 114, and/or 116. Any suitable filter criteria may be employed. Examples include content of source, address field, destination or recipient address fields, time stamp field, subject matter field, and message body field. For example, an obvious searchable content is the name of the business enterprise running the contact center 102 and/or products or services of the enterprises.

The social media gateway 106 can include one or more social media network API 204. As shown in FIG. 2A, the social media gateway 106 may include a social media network API 204 for each social media network 112, 114, and/or 116. As such, the social media gateway 106 can interact with each social media network 112, 114, and/or 116 in the particular (often unique) format or protocol used by the social media network 112, 114, and/or 116. Further, when new social media networks are created, the social media gateway 106 can easily be expanded to interact with those social media networks by adding another social media network API 204. Where social media networks 112 are more standardized, or use substantially similar formats or protocols, a single social media network API can be shared by multiple such social media networks 112-116.

The social media network API 204 can receive messages from and send messages corresponding to the social media network 112, 114, and/or 116. The social media network API 204 can translate a message received from a social media network 112, 114, and/or 116 and send the translated message to a message filter 206. The social media network API 204 can translate the received message into a standard formatted file. For example, the translated message may be represented by an extensible mark-up language (XML) file or other file having a general format. As such, each specific and particular social media network message can be translated into a standard format for use by the dialog system 104. Further, the social media network API 204 can receive a generally or standard format response message, from the dialog system 104 and translate that response into a particularly or specifically formatted response message that can be posted to the corresponding social media network 112, 114, and/or 116.

Messages to the contact center 102 are addressed to the contact center 102. For example, a customer may become a “friend” of the contact center 102 on a social media network 114, such as Facebook. The customer may then address a message to the contact center 102 on Facebook. This non-direct contact is a message that is not sent directly to the contact center 102 but to the contact center's Facebook page. In other embodiments, the contact center 102 receives messages not addressed to the contact center 102. For example, the contact center 102 can receive tweets from Twitter that are “broadcast” rather than addressed to the contact center 102. The contact center 102 may also search for message or content on the social media network 112, 114, and/or 116. Exemplary search criteria include customer name, customer profession, customer home address, customer business address, customer employer name, customer educational or professional background, customer hobby, personal or business interests, customer family profile, and the like. Thus, the social media gateway 106 of the contact center 102 can query, gather, or connect to a live feed of data from a social media network 112, 114, and/or 116 and then apply a filter to the indirect information.

The translated messages from the social media network API 204 can be received by a message filter 206. A message filter 206 can perform some or all of the functions of the content filter 202 and eliminate messages before being sent to the dialog system 104. However, in other embodiments, the message filter 206 eliminates information from within the messages before the trimmed messages are sent to the dialog system 104. For example, a message from a social media network 112 may have three or four interactions between two parties not associated with the contact center 102. Only one of the several postings may be pertinent to the dialog system 104. As such, the message filter 206 can eliminate or delete at least a portion of the other messages for the dialog system 104. Thus, the dialog system 104 receives a message where some of the content of the message has been deleted. The message filter 206 can retrieve heuristics or filter rules from a filter database (not shown), similar to the content filter 202. A substantial difference between the content and message filters 202 and 206 is that the content filter 202 is specific to a particular message format associated with a corresponding social media network 112-116, while the message filter 206 is applied to a standardized or universal format and is therefore common to multiple social media networks 112-116. One skilled in the art will understand the type of rules that may be used to filter information from messages such that only pertinent questions, facts, requests, or information is sent to the dialog system 104.

A message aggregator 208 may also be included with the social media gateway 106. A message aggregator 208 can, in contrast to the message filter 206, combine two or more messages into a packet or grouping that is sent to the dialog system 104. Therefore, the message aggregator 208 can inter-relate or combine messages based on different information within the messages. For example, two messages may be combined based on any of the message fields referenced above, such as the person that posted the message, the subject, the request or question asked, the person the message was sent to, or other information that may be pertinent to the dialog system 104. Thus, the dialog system 104 may be able to respond concurrently to two or more messages based on a grouping provided by the message aggregator 208. If the messages are aggregated or not aggregated, each message can be sent from the social media gateway 106 to the dialog system 104.

The social media gateway 106 can also send responses back to the social media networks 112, 114, and/or 116. A response from an agent in the contact center 102 can be sent to the social media gateway 106. The response may be in a general format and translated. The translated response may then be posted to the appropriate social media network 112, 114, and/or 116 by the social media gateway 106. In other embodiments, the agent may post the response directly to the social media network 112, 114, and/or 116 without sending the response to the social media gateway 106.

An embodiment of the dialog system 104 is shown in FIG. 2B. The dialog system 104 can include one or more components which may hardware, software, or combination of hardware and software. The dialog system 104 can be executed by a computer system such as those described in conjunction with FIGS. 6 and 7. However, in other embodiments, the components described in conjunction with FIG. 2B, are logic circuits or other specially-designed hardware that are embodied in a field programmable gate array (FPGA) or application specific integrated circuit (ASIC). The components contained within the dialog system 104 can include a dialog core 210 that is communication with a message history database 222, an agent interface 224, and a heuristic rules and dialogs database 218. Further, the heuristic rules and dialogs database 218 can be in communication with a dialog creator 220.

The dialog core 210 can include one or more sub-components. For example, the dialog core 210 includes a trend analysis component 212, a text processing component 214, and an analysis tools component 216. These components, similar to the components for the dialog system 104, can be hardware, software, or combination of hardware and software. The dialog core 210 steps through the states of a dialog data structure. A dialog is a set of inputs and associated actions that can be taken which allow for the automatic and structured response to social media requests or messages. For example, if a user asks for a manual, the input of the text word “manual” can cause the dialog system 104 to send information about one or more manuals. In turn, the receiver of the response may respond, in kind, with the selection of a certain user manual. In which case, the dialog data structure may then automatically send the user to a website where the user can retrieve an electronic version of the manual. As such, the dialog data structure allows the dialog core 210 to automate the interaction between the contact center 102 and a person. This automation eliminates the need for agent involvement, in some situations, and makes the contact center 102 more efficient and more effective. Further, the automation expands the contact center's ability to answer numerous messages from the plethora of postings on the numerous social media networks 112, 114, and/or 116.

The dialog creator 220 will create a dialog data structure 300 that steps through various states for each social media message that comes into the contact center 102. The first step might be to send the social media message to the trend analysis component 212, then to the text processing component 214, and then execute a query of a Customer Relationship Management (CRM) system and a CRM database 232 (to find out if this user has an existing order). A CRM database 232 can store information about customers or other data related to customer relations. Finally the dialog data structure might decide that the social media message should be sent to a human agent 228 for processing. The states or node transitions are in the dialog core 210 and make use of many different components that the dialog creator 220 combines in any way the user desires to handle the social media messages. The dialog core 210 can make use of the trend analysis component 212, text processing component 214, or other systems. The dialog core 210 may also interface with a CRM system and/or CRM database 232, external databases, social media user information (e.g., followers, friends, post history, etc. from the social media site), or other systems.

The trend analysis component 212 is operable to analyze trends that occur between two or more messages received by the social media networks 112, 114, and/or 116. The two messages can be from different social media networks, so that the trend analysis component 212 can identify trends across several different social media networks 112, 114, and/or 116. Trends can include multiple occurrences of the same word or phrase, multiple occurrences of a customer identity, product name or service, or multiple occurrences of some other information that might indicate a trend. Further, the trend analysis component 212 may be able to identify escalations in the occurrences of particular text, or identities, or other information, or may identify multiple occurrences over a period of time. The trend analysis component 212 may also be able to apply one or more different algorithms to occurrences of information within the social media networks. For example, the trend analysis component 212 can match the number of occurrences of a phrase or word over a period of time and apply analysis to determine if the occurrences are increasing or decreasing over the period of time.

The text processing component 214 is operable to analyze text of one or more messages from social media networks 112, 114, or 116. Some possible methods for text processing can include Regular Expression, Latent Semantic Indexing (LSI), text part of speech tagging, text clustering, N-Gram document analysis, etc. In addition, for possibly longer documents, (such as, blogs or emails), the text processing component 214 may execute one or more methods of document summarization. The summarization may occur if the social media message will be sent an agent 228 of the contact center 102; the summarization can reduce the amount of information that the agent may manage. The text processing rules or models may be stored in and/or retrieved from a text processing rules database 230. The text processing rules database 230 can be a database as described in conjunction with FIGS. 6 and 7 that stores rules or models used by the text processing component 214.

The text processing component 214 can identify one or more occurrences of a particular text, such as using one or more of the message fields referenced above, in order to associate that social media message with one or more dialogs data structures in the heuristic rules and dialog database 218. For example, the text processing component can look for the word “manual,” in the social media message. If the word “manual” is found, the text processing component 214 may retrieve a dialog from the heuristic rules and dialogs database 218, which communicates with the customer about one or more owner's manuals, repair manuals, or other types of manuals. In another example, if the social media message includes the words, “buy”, “sell”, “price, “discount” or other types of words that may indicate the user or customer wishes to buy a product, the text processing component 214 can retrieve one or more dialogs from the heuristic rules and dialogs database 218 that can assist the customer in purchasing products or services from the enterprise.

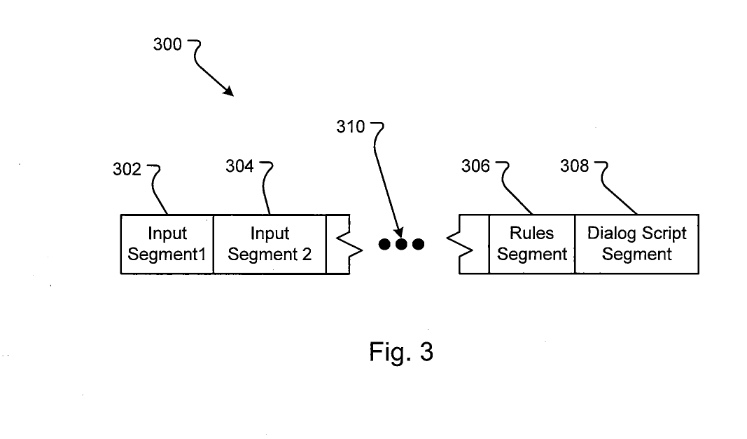

The analysis tools component 216 is operable to analyze response messages received back from an agent interface 224. In analyzing the agent's responses, the analysis tools component 216 can determine if the dialog data structures 300 (FIG. 3) originally retrieved by the text processing component 214 met the needs of the customer. In the analysis, the agent may enter one or more items of information, for the analysis tools component 216, about the response and about how the response matched with the dialog data structures 300. The analysis tools component 216 can review the response and determine if it was similar to the response provided by the dialog data structure 300. Thus, the analysis tools component 216 can provide information to the dialog core 210 or the dialog creator 220 to improve the dialog data structures 300 (FIG. 3) that are included in the heuristic rules and dialogs database 218.

The message history database 222 can be any database or data storage system as described in conjunction with FIGS. 6 and 7. Thus, the message history database 222 can store data in data fields, objects, or other data structures to allow other systems to retrieve that information at a later time. The message history database 222 can store previous messages or information about previous messages. Thus, for example, if the trend analysis component 212 is analyzing several messages over a period of time, the trend analysis component 212 can retrieve information about previous messages associated with the current analysis from the message history database 222. As such, the trend analysis component 212 can better detect trends occurring at the social media networks 112, 114, and/or 116. The data stored by the message history database 222 can include the entire message or only a portion of the message, and in some circumstances, include metadata about the message(s).

The heuristic rules and dialogs database 218 can be any type of database or data storage system as described in conjunction with FIGS. 6 and 7. The heuristic rules and dialogs database 218 can store information and data fields, data objects, and/or any other data structures. An example of information stored within the heuristic rules and dialogs database 218 is described in conjunction with FIG. 3. The heuristic rules and dialogs database 218 stores rules and dialogs that automate responses to received social media messages. The dialogs control the interaction between the dialog core 210 and the social media network 112, 114, and/or 116. The dialogs or heuristic rules can be created by a dialog creator 220. Thus, the dialog creator 220 can interface with the user input 226 to receive information about dialogs. The user input 226 is then used to form the states and responses for a dialog.

An agent interface 224 is a communication system operable to send action items to contact center agents, in the contact center 102. An agent can be a person or other system that is operable to respond to certain questions or requests from a customer. For example, the agent can be a person that has specialized expertise in a topic area, such as technical support. The agent interface 224 can format the social message into an action item and forward that message to one or more agents 228. The agent interface 224 can also receive response(s) back from the agents 228. The information provided by the agent may be used by the dialog core 210 to complete a response to the social media message. For example, the information may classify the social media message (e.g., sales, service, etc.). In other embodiments, the response is a complete response to the social media message that can be posted to the social media network 112, 114, and/or 116.

An embodiment of a dialog data structure 300 is shown in FIG. 3. The dialog data structure 300 can be stored in several different forms of databases, such as relational databases, flat files, object-oriented databases, etc. Thus, while the term “data field” or “segment” is used, the data may be stored in an object, an attribute of an object, or some other form of data structure. Further, the dialog data structure 300 can be stored, retrieved, sent, or received during the processing of dialogs by the dialog core 210 or the dialog creator 220. The dialog data structure 300 stores one or more items of information in one or more data fields. The numeric identifiers (e.g. 302, 304, etc.) shown in FIG. 3 can identify, in one or more fields or segments, either the data field or segment or the data stored in the data field or segment.

The dialog data structure 300 can include one or more input segments, such as, input segment 1 302 and input segment 2 304, a rules segment 306, and/or a dialog script segment 308. Input segments 302 and 304 each include one or more fields comprising the one or more inputs that may be required to associate a social media message with the dialog data structure 300. The inputs segments 302 and 304 may include a customer identity, a respective customer type, a text word, a phrase, or other information that indicates that the dialog data structure 300 is associated with the social media messages. The input segments 302 and 304 may also include certain trends that the trend analysis component 212 can identify. As such, if a trend is identified and associated with the inputs in input segments 1 302 and/or 2 304, the dialog data structure 300 can be retrieved and used by the dialog core 210. While there are only two input segments 1 302 and 2 304 shown in FIG. 3, there may be more or fewer input segments associated with the dialog data structure 300, as indicated by ellipses 310.

The rules segment 306 can include one or more heuristic rules that either help with the association of the respective dialog data structure 300 with the social media message or control the interaction between the dialog core 210 and the social media customer. For example, the rule 306 can state that the dialog data structure 300 applies only if the social media message includes input segment 1 302 but not input segment 2 304. One skilled in the art will be able to identify other types of rules that may govern the association of the dialog data structure 300 with the social media message. In other embodiments, the rules segment 306 states that if the social media message includes inputs 1 302 and/or 2 304, then the dialog core 210 should respond with a certain type of action.

Generally, a dialog script segment 308 includes a script of actions or responses that direct one or more other components, such as the dialog core 210 (FIG. 2B), to conduct the actions or send the responses. The dialog script segment 308 can include the one or more responses required by the dialog core 210. If the dialog script segment 308 applies (that is, if the social media message is requesting a certain type of information), the dialog script segment 308 may include the one or more responses that the dialog core 210 should communicate to respond to that social media message. The dialog script segment 308 can also include a response and a pointer to another dialog script segment 308 or another dialog data structure 300. Further, the dialog script segment 308 may have one or more actions that may be taken by another component after a secondary response is received by a customer. Thus, the dialog script segment 308 can allow an interaction to continue with a social media user over a period of time and several interactions between the user and the contact center 102.

It should be noted that the dialog script segment 308 can reference one or more other dialog data structures 300. Thus, the dialog script segment 308 can direct the dialog core 210 to reference at least one other dialog data structure 300 to further act on the social media message. Further, the social media message can be subject of two or more dialog script segments 308, and direct the dialog core 210 to complete two dialog script segments on the social media message. Also, dialog script segments 308 may not be associated with a response but direct the dialog core 210 to complete other actions, such as populating databases or gathering information.

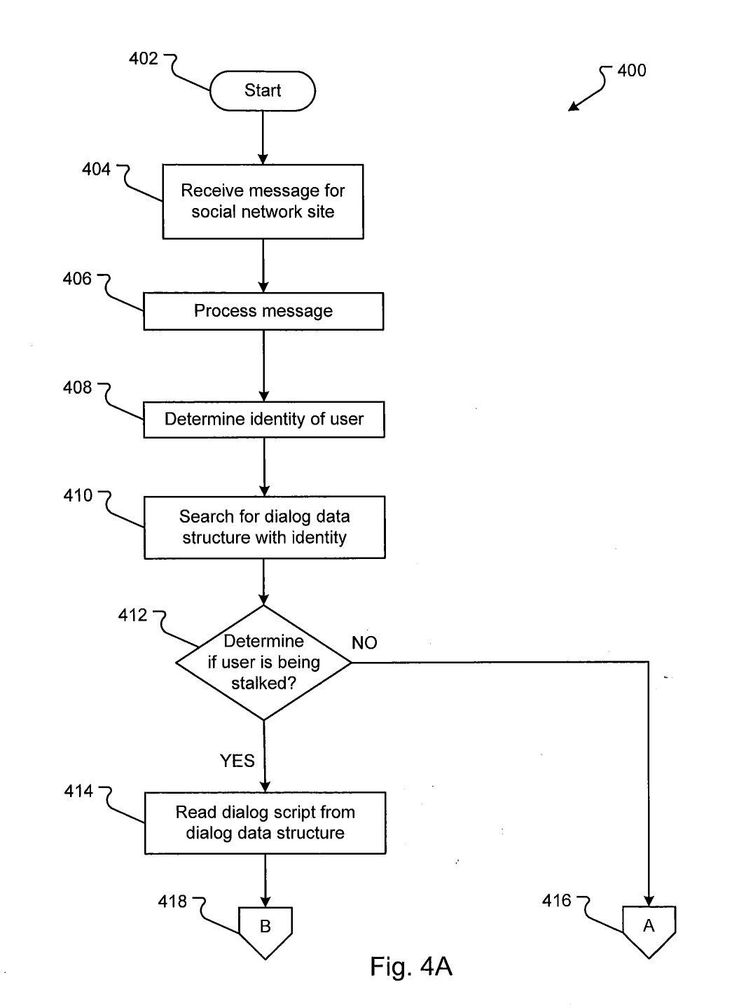

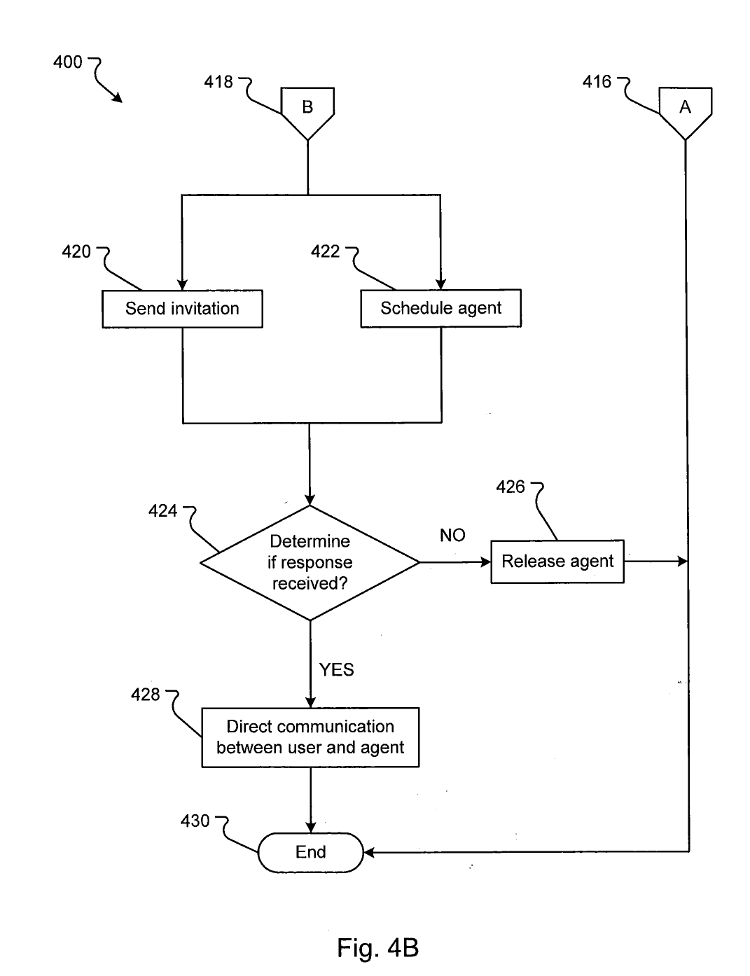

An embodiment of a process or method 400 for engaging a social media user in a communication is shown in FIGS. 4A and 4B. Generally, the method 400 begins with a start operation 402 and terminates with an end operation 430. While a general order for the steps of the method 400 are shown in FIGS. 4A and 4B, the method 400 can include more or fewer steps or arrange the order of the steps differently than those shown in FIGS. 4A and 4B. The method 400 can be executed as a set of computer-executable instructions executed by a computer system and encoded or stored on a computer readable medium. Hereinafter, the method 400 shall be explained with reference to the systems, components, modules, software, data structures, etc. described in conjunction with FIGS. 1-3.

A contact center 102 receives a social media message from a social media network 112, in step 404. The social media gateway 106 of the contact center 102 can receive the message. A content filter 202a passes the social media message through to a social media network API 204. The social media message may then be passed through a message filter 206 and a message aggregator 208 to be sent to a dialog system 104.

The dialog system 104 can process the social media message, in step 406. The dialog core 210, of the dialog system 104, can process the message to determine if the user that posted the social media message is being stalked. To determine if the user is being stalked, the dialog core 210 first determines the identity of the user, in step 408. The dialog core 210 processes the message with a text processing component 214 to extract the identity of the user from the social media message. For example, the identity of the user may be a user name, email, or some other identifying information within the social media message. This identifying information may be parsed and extracted from the social media message.

Once the identity of the user is determined from the social media message, the text processing component 214 can search a message history database 222, CRM database 232 or one or more other sources to determine other identities which may be associated with the identity extracted from the social media message. For example, if a username is used in a social media message, such as “Big Dog 26”, the text processing component may relate the “Big Dog 26” user name with an actual name of the user, such as “Bill Smith.”

After the possible identities of the user are determined, the text processing component 214 may then search one or more dialog data structures 300 stored in a heuristic rules and dialogs database 218 for the identities, in step 410. In searching the dialog data structures 300, the text processing component 214 analyzes input segment 1 302, input segment 2 304, and one or more other input segments to locate a user name that is the same as the identity extracted from the social media message or an identity that is related to the identity in the social media message. The text processing component 214, of the dialog core 210, then determines if the user is being stalked, in step 412. To determine if the user is being stalked, the text processing component 214 determines if one of the user identities is located in the dialog data structure 300. If the user identity is in an input segment 1 302, input segment 2 304, or one or more other input segments, then the text processing component 214 understands that the user is subject to stalking. If the user is being stalked, the determination step 412 flows “YES” to step 414. If the user is not being stalked, the step 412 flows “NO” to off-page connector A 416.

If the user is being stalked, the text processing component 214 reads the dialog script from the dialog script segment 308 from the dialog data structure 300, in step 414. The dialog script includes the information that is sent to the user as an invitation and what actions the dialog core 210 will complete if the user is being stalked. The method 400 flows through off-page connector B 418 to FIG. 4B. The dialog script then directs the text processing component 214 to send an invitation to the user on the social media network 112, or by another communication media, to interact with an agent, in step 420. Thus, the dialog script can contain the wording and information required for the invitation in which the text processing component 214 can compose for the dialog core 210 to send to the social media gateway 106. The invitation can be sent through the social media network API 204 to the social media network 112. As such, the user may receive an invitation in response to the posted message in real time or near real time. It should be noted that real near time or real time means that the invitation arrives at the social media network soon after when the user posts the message. For example, the invitation should arrive within a pre-determined period of time. The time limit for the pre-determined period of time may be set and listed in the dialog script. Regardless, the pre-determined period of time with which the invitation should arrive should be within seconds or minutes of the posting of the social media message. Therefore, the contact center 102 can quickly contact the user on the social media network 112 and then quickly engage the user in a communication.

Further, the text processing component 214 can be directed by the dialog script to schedule a human agent to conduct a communication, in step 422. The text processing component 214 may send a request to the agent interface 224 for a human agent to be scheduled for the communication. The agent interface 224 may then schedule an agent 228 to conduct the communication. In scheduling the agent, the agent interface 224 may have an agent 228 set aside for the communication, such that, if the invitation is returned positively from the user, the agent 228 can quickly engage the user in the communication.

Beyond sending the invitation through the social media network API 204 to the social media network 112, it may be possible for the dialog core 210 to send an invitation and schedule an agent for a different type of communication media. For example, some social media messages include presence or location information. For example, a Tweet on Twitter can include the current location of the user. Thus, if the user is Tweeting from their home, the text processing component 214 can use that location information in the Tweet to retrieve a phone number associated with the location, from a CRM database 232. As such, the text processing component 214 can create an invitation for the phone that is sent not to the social media network 112 but to the telephone of the user. The invitation is sent through the dialog core 210 to communication device 110. Thus, the dialog core 210 is able to engage the user in other mediums of communication beyond just the social media network 112.

After the invitation is sent, the dialog core 210 determines if a response to the invitation is received, in step 424. In order to engage the user in a communication, the dialog core 210 needs to receive a response that the user is interested in the communication. This positive response can be a subsequent post in the social media network 112 or a positive response over a communication device 110 or other communication media. If the social media gateway 106 or dialog system 104 receives a positive response, then step 424 proceeds “YES” to step 428. However, if no response is received, then step 424 proceeds “NO’ to step 426. Or, if a negative response is received because the user does not desire to conduct a communication, step 424 flows “NO” to step 426. In embodiments, a timer is set for a pre-determined amount of time as prescribed by the dialog script 308 to wait for the response to an invitation. For example, the dialog core 210 may need to wait 5 minutes for a response before it determines no response is received. As such, the dialog core 210 stops trying to engage the user or sends another invitation after the timer has expired.

If no response is received to the invitation or the response is negative, the dialog core 210 releases the agent 228, in step 426. As explained in step 422, an agent 228 is scheduled to conduct the communication in real time or near real time. Thus, there is little gap in receiving the response to the invitation and the agent 228 engaging in the communication. Thus, if no response is received or if the response is negative, the agent 228 must be released. As such, the text processing component 214 can send a message through the agent 228 interface 224 to the agent that releases the agent 228 from needing to communicate with the user. As such, the agent 228 can then conduct other actions or receive other messages or phone calls.

If a response is received and the response is positive, the dialog core 210 directs a communication between the user and the agent 228, in step 428. In embodiments, the invitation response is sent through the agent interface 224 to the agent 228 to begin the communication. The agent 228 may then begin the communication, and the dialog system 104 is released from further action with the social media message.

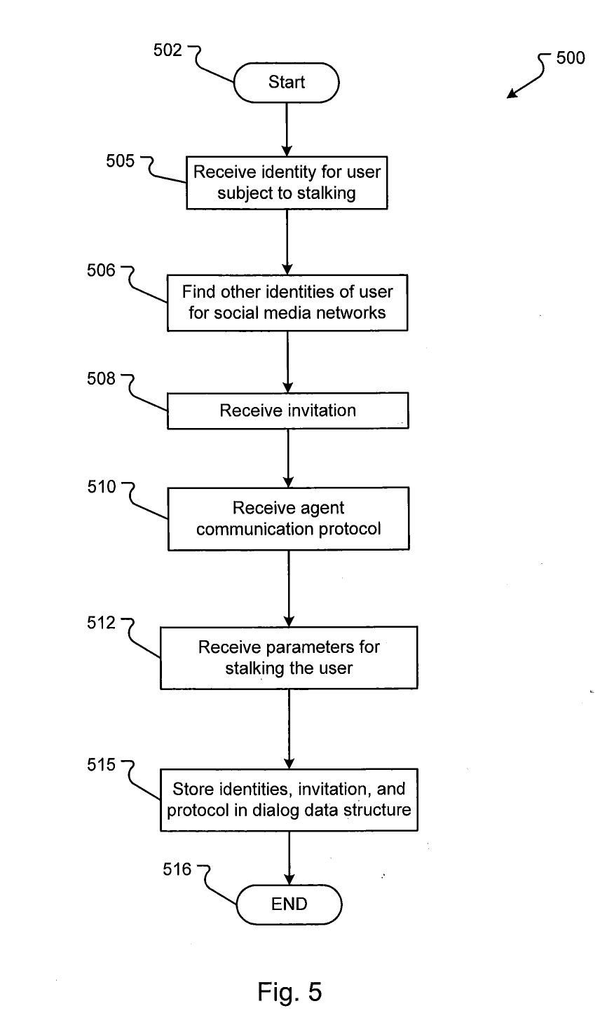

An embodiment of a method 500 for creating a dialog data structure for staking social media user(s) is shown in FIG. 5. Generally, the method 500 begins with a start operation 502 and terminates with an end operation 516. While a general order for the steps of the method 500 are shown in FIG. 5, the method 500 can include more or fewer steps or arrange the order of the steps differently than those shown in FIG. 5. The method 500 can be executed as a set of computer-executable instructions executed by a computer system and encoded or stored on a computer readable medium. Hereinafter, the method 500 shall be explained with reference to the systems, components, modules, software, data structures, etc. described in conjunction with FIGS. 1-3.

The dialog creator 220 receives an identity for a user that is subject to stalking, in step 506. The identity may be the name of the user, a user name, an email address, or some other identifying information. The dialog creator 220 may look for other identities of the user for other social media networks 1 112, 2 114, or 3 116, in step 506. The dialog creator 220 can send the received identity for the user to the dialog core 210 to search the message history database 222 and/or CRM database 232 for other identities associated with the user. In other embodiments, dialog creator 220 can search one or more social media networks 1 112, 2 114, and/or 3 116 to search for the user identity and then locate other identities. After the identities are determined, or received, the dialog creator 220 can receive an invitation, in step 508. The invitation includes the text or information that is used in an invitation sent to the user to engage in a communication. The invitation may be text and then converted to a voice invitation for other communication media.

In still other embodiments, the invitation may be voice communicated or translated into text for social media networks 112, 114, or 116.

The dialog creator 220 can then receive an agent communication protocol, in step 510. The agent communication protocol includes the actions or steps required to schedule an agent for communication. The actions may include which agent 228 to schedule, when to schedule the agent based on when the invitation is sent or when a social media message is received, or may include other information for how to engage an agent 228 in a communication with a social media user.

The dialog creator 220 may then receive parameters for the stalking of the user, in step 512. The parameters may include when to send the invitation based on the receipt of the social media post, may include a time limit for the stalking, or may include other information on how to conduct the stalking. The parameters for the stalking can be incorporated in the rules segment 306 of the data dialog structure 300. Thus, the parameters dictate how the dialog core 210 will conduct the stalking.

The information received including the identity received, the identities determined, the invitation, the protocol, and the parameters can be stored in a dialog data structure 300, in step 516. Thus, the dialog creator 220 can create a dialog data structure 300. The one or more identities of the user can be stored in the input segment 1 302 and/or 2 304. The parameters for stalking the user can be stored in the rules segment 306. The agent communication protocol and invitation information may be incorporated in a dialog script in a dialog script segment 308. As such, the dialog creator 220 can create a data dialog structure 300 operable to direct the stalking of a user. The dialog creator 220 can then store the dialog data structure 300 in the heuristic rules and dialogs database 218. The dialog creator 220 can receive two or more of the identities for two or more users of social media networks 1 112, 2 114, or 3 116 and store different dialog data structures 300 in the heuristic rules and dialog database 218. As such, the dialog core 210 can stalk two or more users concurrently and conduct communications with those users concurrently if both users are submitting social media messages at the same time or at approximately the same time.

FIG. 6 illustrates a block diagram of a system 600 that may function as servers, computers, or other systems provided herein. The system 600 includes one or more user computers 605, 610, and 615. The user computers 605, 610, and 615 may be general purpose personal computers (including, merely by way of example, personal computers, and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 605, 610, 615 may also have any of a variety of applications, including for example, database client and/or server applications, and web browser applications. Alternatively, the user computers 605, 610, and 615 may be any other electronic device, such as a thin-client computer, Internet-enabled mobile telephone, and/or personal digital assistant, capable of communicating via a network 620 and/or displaying and navigating web pages or other types of electronic documents. Although the exemplary system 800 is shown with three user computers, any number of user computers may be supported.

System 600 further includes a network 620. The network 620 may can be any type of network familiar to those skilled in the art that can support data communications using any of a variety of commercially-available protocols, including without limitation SIP, TCP/IP, SNA, IPX, AppleTalk, and the like. Merely by way of example, the network 620 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 602.11 suite of protocols, the Bluetooth™ protocol known in the art, and/or any other wireless protocol); and/or any combination of these and/or other networks. The network 620 may be the same or similar to network 106.

The system may also include one or more server computers 625, 630. One server may be a web server 625, which may be used to process requests for web pages or other electronic documents from user computers 605, 610, and 620. The web server can be running an operating system including any of those discussed above, as well as any commercially-available server operating systems. The web server 625 can also run a variety of server applications, including SIP servers, HTTP servers, FTP servers, CGI servers, database servers, Java servers, and the like. In some instances, the web server 625 may publish operations available operations as one or more web services.

The system 600 may also include one or more file and or/application servers 630, which can, in addition to an operating system, include one or more applications accessible by a client running on one or more of the user computers 605, 610, 615. The server(s) 630 may be one or more general purpose computers capable of executing programs or scripts in response to the user computers 605, 610 and 615. As one example, the server may execute one or more web applications. The web application may be implemented as one or more scripts or programs written in any programming language, such as Java™, C, C#™, or C++, and/or any scripting language, such as Perl, Python, or TCL, as well as combinations of any programming/scripting languages. The application server(s) 630 may also include database servers, including without limitation those commercially available from Oracle, Microsoft, Sybase™, IBM™ and the like, which can process requests from database clients running on a user computer 605.

The web pages created by the web application server 630 may be forwarded to a user computer 605 via a web server 625. Similarly, the web server 625 may be able to receive web page requests, web services invocations, and/or input data from a user computer 805 and can forward the web page requests and/or input data to the web application server 830. In further embodiments, the server 630 may function as a file server. Although for ease of description, FIG. 6 illustrates a separate web server 625 and file/application server 630, those skilled in the art will recognize that the functions described with respect to servers 625, 630 may be performed by a single server and/or a plurality of specialized servers, depending on implementation-specific needs and parameters. The computer systems 605, 610, and 615, file server 625 and/or application server 830 may function as the system, devices, or components described in FIGS. 1-3.

The system 600 may also include a database 635. The database 635 may reside in a variety of locations. By way of example, database 635 may reside on a storage medium local to (and/or resident in) one or more of the computers 605, 610, 615, 625, 630. Alternatively, it may be remote from any or all of the computers 605, 610, 615, 625, 630, and in communication (e.g., via the network 620) with one or more of these. In a particular set of embodiments, the database 635 may reside in a storage-area network (“SAN”) familiar to those skilled in the art. Similarly, any necessary files for performing the functions attributed to the computers 605, 610, 615, 625, 630 may be stored locally on the respective computer and/or remotely, as appropriate. In one set of embodiments, the database 635 may be a relational database, such as Oracle 10i™, that is adapted to store, update, and retrieve data in response to SQL-formatted commands.

FIG. 7 illustrates one embodiment of a computer system 700 upon which the servers, computers, or other systems or components described herein may be deployed or executed. The computer system 700 is shown comprising hardware elements that may be electrically coupled via a bus 755. The hardware elements may include one or more central processing units (CPUs) 705; one or more input devices 710 (e.g., a mouse, a keyboard, etc.); and one or more output devices 715 (e.g., a display device, a printer, etc.). The computer system 700 may also include one or more storage devices 720. By way of example, storage device(s) 720 may be disk drives, optical storage devices, solid-state storage devices such as a random access memory (“RAM”) and/or a read-only memory (“ROM”), which can be programmable, flash-updateable and/or the like.

The computer system 700 may additionally include a computer-readable storage media reader 725; a communications system 730 (e.g., a modem, a network card (wireless or wired), an infra-red communication device, etc.); and working memory 740, which may include RAM and ROM devices as described above. In some embodiments, the computer system 700 may also include a processing acceleration unit 735, which can include a DSP, a special-purpose processor, and/or the like.

The computer-readable storage media reader 725 can further be connected to a computer-readable storage medium, together (and, optionally, in combination with storage device(s) 720) comprehensively representing remote, local, fixed, and/or removable storage devices plus storage media for temporarily and/or more permanently containing computer-readable information. The communications system 730 may permit data to be exchanged with the network 720 and/or any other computer described above with respect to the system 700. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 700 may also comprise software elements, shown as being currently located within a working memory 740, including an operating system 745 and/or other code 750, such as program code implementing the ancillary server 300. It should be appreciated that alternate embodiments of a computer system 700 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for conducting a near real-time interaction between a user on a social media network and a contact center, the method comprising:
a processor receiving a first message from the social media network;
the processor determining an identity for the user from the first message;
the processor determining if the identity of the user is being stalked; and
if the identity of the user is being stalked, the processor sending an invitation to engage in a communication.

2. The method as defined in claim 1, further comprising:
the processor waiting for a response to the invitation;
if the response is received, determining if the user desires to engage in the communication,
if the user does desire to engage in the communication, directing a contact center agent to begin communicating with the user;
if the user does not desire to engage in the communication, freeing the contact center agent from communicating with the user.

3. The method as defined in claim 2, wherein the contact center agent communicates with the user over the social media network which the user posted the first message.

4. The method as defined in claim 2, wherein the contact center agent communicates with the user over a second communication medium different from the social media network which the user posted the first message.

5. The method as defined in claim 4, wherein the second communication medium is a telephone, email, or a text message.

6. The method as defined in claim 4, wherein the first message includes presence information and wherein the second communication medium is determined based on the second communication medium being in proximity with a location of the user based on the presence information.

7. The method as defined in claim 1, wherein determining if the identity of the user is being stalked according to a dialog script comprises: the processor searching for a dialog data structure in a heuristic rules and dialogs database that includes the identity of the user in an input segment of the dialog data structure.

8. The method as defined in claim 6, further comprising:
the processor retrieving the dialog data structure from the heuristic rules and dialogs database that includes the identity of the user in the input segment of the dialog data structure; and
the processor reading the invitation from the dialog script of the dialog data structure.

9. The method as defined in claim 8, further comprising:
the processor waiting for a response to the invitation;
if the response is received, the processor determining if the user desires to engage in the communication;
the processor scheduling, according to the dialog script, a contact center agent to communicate with the user;
if the user does desire to engage in the communication, the processor directing, according to the dialog script, a contact center agent to begin communicating with the user; and
if the user does not desire to engage in the communication, the processor freeing, according to the dialog script, the contact center agent from communicating with the user.

10. The method as defined in claim 1, wherein the invitation is sent in real time.

11. A computer readable medium having stored thereon instructions that cause a computing system to execute a method for conducting an interaction between a user on a social media network and a contact center, the instructions comprising:
instructions to receive a first message from a user posting a first message to the social media network;
instructions to determine a first identity for the user from the first message;
instructions to determine if the first identity of the user is being stalked according to a dialog data structure;
instructions to schedule, according to a dialog script in the dialog data structure, the contact center agent to communicate with the user; and
instructions to send, according to the dialog script and in near real time, an invitation to engage in the communication with a contact center agent.

12. The method as defined in claim 11, further comprising:
instructions to determine if the user desires to engage in the communication;
if the user does desire to engage in the communication, instructions to direct, according to the dialog script, the contact center agent to begin communicating with the user; and
if the user does not desire to engage in the communication, instructions to free, according to the dialog script, the contact center agent from communicating with the user.

13. The method as defined in claim 12, wherein determining if the user desires to engage in the communication comprises:
instructions to wait, according to the dialog script, for a response to the invitation for a predetermined amount of time;
if the response is received, instructions to determine, according to the dialog script, if the response agrees to engage in the communication;
if the response agrees to engage in the communication, instructions to begin, according to the dialog script, the communication;
if the response does not agree to engage in the communication, instructions to free, according to the dialog script, the contact center agent from communicating with the user
if no response is received during the predetermined amount of time, instructions to generate, according to the dialog script, a time out; and
when a time out is generated, instructions to free, according to the dialog script, the contact center agent from communicating with the user.

14. The method as defined in claim 11, further comprising:
instructions to receive a second message from a second user posting a second message to the social media network;
instructions to determine a second identity for the second user from the second message;
instructions to determine if the second identity of the second user is being stalked according to a second dialog data structure;
if the second identity of the second user is being stalked, instructions to retrieve a second dialog script from the second dialog data structure;
instructions to execute a second dialog script concurrently with the dialog script;
instructions to schedule, according to the second dialog script, the contact center agent to communicate with the second user;
instructions to send, according to the second dialog script and in near real time, a second invitation to engage in a second communication with the contact center agent;
instructions to determine if the second user desires to engage in the second communication;
if the second user does desire to engage in the second communication, instructions to direct, according to the second dialog script, the second contact center agent to begin communicating with the second user; and
if the second user does not desire to engage in the second communication, instructions to free, according to the second dialog script, the second contact center agent from communicating with the second user.

15. A communication system comprising:
a social media gateway in communication with a social media network, the social media gateway operable to receive a first message from the social media network, wherein a user posts the first message to the social media network, and operable to send an invitation to the user;
a dialog system in communication with the social media gateway, the dialog system to process the first message, operable to execute a dialog script, wherein the dialog script directs the communication system to stalk the user associated with the first message, in response to executing the dialog script, operable to generate the invitation, and operable to coordinate a communication between the user and a contact center agent; and
a contact center in communication with the dialog system, the contact center operable to provide the contact center agent to communicate with the user.

16. The communication system as defined in claim 15, wherein the dialog system comprises:
a dialog core in communication with the social media gateway, the dialog core operable to stalk the user according to the dialog script and operable to send the invitation;
a heuristic rules and dialogs database in communication with the dialog core, the heuristic rules and dialogs database operable to store the dialog script; and
a dialog creator in communication with the heuristic rules and dialogs database, the dialog creator operable to create a dialog data structure and operable to store the dialog data structure into the heuristic rules and dialogs database.

17. The communication system as defined in claim 16, wherein the dialog creator is operable to:
receive the identity of the user;
receive the invitation associated with stalking of the user;
receive an agent communication protocol;
receive a parameter associated with stalking the user; and
store the identity, the invitation, the agent communication protocol, and the parameter in the dialog data structure.

18. The communication system as defined in claim 17, wherein the dialog system further comprises:
a message history database in communication with the dialog core, the message history database operable to store an interaction history associated with the first message; and
an agent interface in communication with the dialog core and an agent associate with the contact center, the agent interface operable to send the first message to an agent and operable to receive the first response to the first message from the agent.

19. The communication system as defined in claim 18, wherein the dialog core is further operable to:
search the message history database for another identity associated with the user; and
store the other identity in the dialog data structure.

20. The communication system as defined in claim 16, wherein the dialog core further comprises a text processing component operable to determine if an identity associated with a user is the identity being stalked and, if the user accepts the invitation, directing an agent to communicate with the user through an agent interface.
